(19) United States
(12) Patent Application Publication
(10) Pub. No.: US 2023/0059052 A1
(43) Pub. Date: Feb. 23, 2023

(54) ARTIFICIAL EYE SYSTEM

(71) Applicant: Meta Platforms Technologies, LLC, Menlo Park, CA (US)

(72) Inventors: Zhang Jia, San Jose, CA (US); Chandra Sekhar Kakani, Fremont, WA (US); Yijing Fu, Redmond, WA (US)

(21) Appl. No.: 17/406,721

(22) Filed: Aug. 19, 2021

(51) Int. Cl. G06F 3/01; G02B 5/26; G02B 3/04; G02B 27/00; G02B 5/20; H04N 5/225; H04N 5/232; G06T 7/80; G06T 7/00

(52) U.S. Cl. CPC G06F 3/013; G02B 5/26; G02B 3/04; G02B 27/0093; G02B 5/208; H04N 5/2254; H04N 5/23299; G06T 7/80; G06T 7/97

(57) ABSTRACT

A lens assembly includes an optical element having an outward-facing surface with a cornea-shaped contour. The lens assembly includes a housing that carries an optical element. The housing at least partially houses an image sensor. The image sensor is positioned to receive image light from the optical element. The lens assembly is an artificial eye system that may be used to mimic a human eye while operating or testing a head-mounted display.

### TECHNICAL FIELD

This disclosure relates generally to optics and in particular to optical calibration systems for head-mounted displays.

### BACKGROUND INFORMATION

Virtual reality (“VR”) and augmented reality (“AR”) systems and applications continue to expand in availability and in use. As these technologies transition from the recreational industry to educational, manufacturing, and other industries, the importance of quality assurance is increasing. Poor visibility or inaccurate sensing can lead to a poor user experience or to operator error, which may be detrimental to user engagement (in education) or may lead to poor yield quality (in manufacturing). Simply placing a camera behind a VR or AR system is an inadequate solution because information displayed in VR/AR can depend on more than just the presence of a user near a system.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates an example of an optical calibration system with an artificial eye system that includes a cornea-shaped lens, in accordance with aspects of the disclosure.

FIG. 2 a flow chart of an example process of operating an optical calibration system, in accordance with aspects of the disclosure.

FIGS. 3A, 3B, 3C, and 3D illustrate side views and a front view of example embodiments of an artificial eye system, in accordance with aspects of the disclosure.

FIGS. 4A, 4B, and 4C illustrate side views of different cornea dimensions for an artificial eye system, in accordance with aspects of the disclosure.

FIGS. 5A and 5B illustrate examples of head-mounted displays, in accordance with aspects of the disclosure.

FIG. 6 illustrates a flow chart of an example process of operating an artificial eye system, in accordance with aspects of the disclosure.

### DETAILED DESCRIPTION

Embodiments of an optical calibration system and artificial eye system are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.4 μm.

In aspects of this disclosure, the term “transparent” may be defined as having greater than 90% transmission of light. In some aspects, the term “transparent” may be defined as a material having greater than 90% transmission of visible light.

Virtual reality (“VR”) and augmented reality (“AR”) systems can provide rich, engaging, and realistic user experiences by adapting displayed content to a user's gaze. A user's gaze can be described as the orientation of a user's eye(s). Some eye tracking systems use the cornea, pupil, and/or iris of an eye to track where the eye is oriented. When an eye's orientation changes from being directed at a center of a display to being directed to an upper-left, lower-right, or some other location on a display, an eye tracking system can detect the change in orientation and cause a VR/AR system to update a display accordingly.

With millions of VR/AR headsets being manufactured and sold on a quarterly basis, manual testing of each device is impractical. However, merely replacing a human tester with a static camera is insufficient. To confirm the responsiveness of the VR/AR display and the quality of displayed images, an optical calibration system is needed that enables eye tracking functionality while concurrently capturing user-perspective visual information.

Implementations of the present disclosure include an artificial eye system having a lens that is shaped like the cornea of a human eye. The artificial eye system also includes a housing, a camera system to capture image light from the lens, and an iris structure positioned between the lens and camera system, according to an embodiment. The housing for the lens may include a cornea region (which encloses the lens) and a sclera region. The artificial eye system may be mounted to an orientation stage that repositions the artificial eye system into various orientations. With these features, the artificial eye system simulates human eye properties and behaviors to support eye tracking system operations and VR/AR testing.

In implementations of this disclosure, the lens of the artificial eye system has an outward facing surface that has a cornea-shaped contour. The cornea-shaped contour may be aspherical. The cornea-shaped contour may be spherical and have a radius that is different than a radius of the sclera region of the housing. The lens may be attached to or integrated with the cornea region of the housing. The lens may operate like a human cornea to focus light to the camera system to enable the camera system to capture images in a manner similar to how a human eye might perceive the images. The lens focuses image light through a pupil opening that is formed in the iris structure. The iris structure may include a slightly-reflective matte-finish that mimics properties of an iris of a human eye. The pupil may be an entrance pupil for the camera system.

The camera system may include an image sensor and an optical system. The image sensor is configured to convert received image light into image data. The optical system may include one or more optical elements (e.g., lenses) positioned between the pupil and the image sensor to focus light onto the image sensor. The camera system may be coupled to the housing to rotate in alignment with the lens, pupil, and housing.

In implementations of this disclosure, the artificial eye system is incorporated into an optical calibration system to operate with a head-mounted display (“HMD”). The optical calibration system includes the HMD, the artificial eye system, an orientation controller, and processing logic. The HMD may include a display and an eye tracking system, among other components. The display projects image light of images or information that may be based on an orientation of the artificial eye system. The eye tracking system may be used to determine the orientation of the artificial eye system and provide orientation information to the processing logic. The processing logic may compare a known orientation of the artificial eye system (e.g., set by the orientation controller) against the received orientation that is determined by the eye tracking system. Comparing known orientation against measured orientation may facilitation calibration of the camera system and/or the eye tracking system. The artificial eye system (and camera system) may then be used to execute quality assurance testing on HMDs in a production environment, with image data that may be similar to what a human eye may perceive.

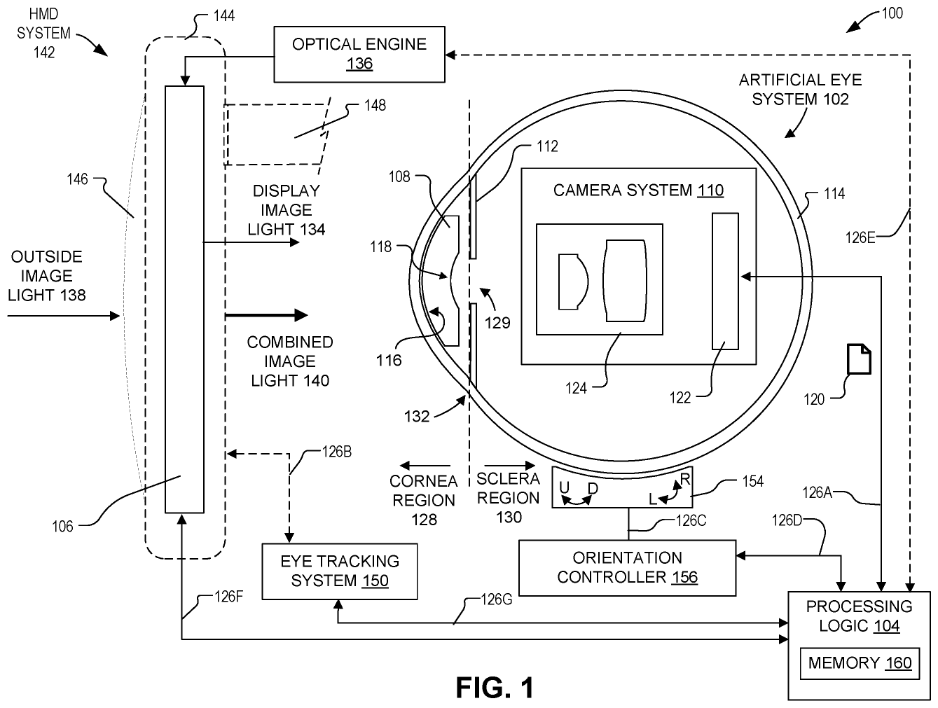

These and other embodiments are described in more detail in connection with FIGS. 1-6.

FIG. 1 illustrates an optical calibration system 100 that is configured to monitor, calibrate, and test head-mounted display systems, in accordance with embodiments of the disclosure. Optical calibration system 100 includes an artificial eye system 102 that is coupled to processing logic 104 and that is configured to receive image light from a display 106, according to an embodiment. The artificial eye system 102 resolves deficiencies in traditional optical calibration systems by incorporating a lens, pupil, and housing that resemble a human eye.

Artificial eye system 102 is a lens assembly including a number of components configured to receive image light and convert the image light into image data. Artificial eye system 102 includes a lens 108, a camera system 110, and an iris structure 112 that is positioned between lens 108 and camera system 110. Artificial eye system 102 also includes a housing 114 configured to carry lens 108, iris structure 112, and/or camera system 110, according to an embodiment.

Lens 108 is configured to be shaped like part of a human eye to mimic light transmission properties of a cornea of a human eye. Lens 108 includes an outward surface 116 that is shaped like the cornea of a human eye. Outward surface 116 is an outward facing surface that receives light (e.g., image light) from outside artificial eye system 102. Outward surface 116 is a concave surface. A contour of outward surface 116 includes a cornea shape that may be aspherical or that may be spherical. Lens 108 also includes an inward surface 118 that is configured to transmit image light to camera system 110. Inward surface 118 may be straight, convex, and/or concave to transmit light through iris structure 112 to camera system 110, according to an embodiment.

Camera system 110 is positioned proximate to lens 108 to receive image light from lens 108. Camera system 110 is configured to convert the image light into image data 120. Camera system 110 may output image data 120 to, for example, processing logic 104 for analysis. Camera system 110 may be positioned within housing 114. Camera system 110 may be mounted to, carried by, or structurally supported by housing 114. Camera system 110 may be partially enclosed by housing 114 or may be fully enclosed by housing 114.

Camera system 110 includes an image sensor 122 and an optical system 124 for generating image data 120 from image light received from lens 108. Image sensor 122 may be a complementary metal oxide semiconductor (“CMOS”) image sensor or a charge-coupled device (“CCD”) image sensor. Image sensor 122 includes an array of pixels that are each responsive to photons received from lens 108 through iris structure 112. In one embodiment, image sensor 122 has image sensor pixels having a pixel pitch of one micron or less. The pixel resolution of image sensor 122 may vary depending on the application. In one embodiment, image sensor 122 is 1920 pixels by 1080 pixels. In one embodiment, image sensor 122 is a 40 megapixel or greater image sensor. In one embodiment, image sensor 122 includes processing logic (e.g., a system on a chip (“SOC”) that facilitates communication with processing logic 104 or other components within optical calibration system 100. The processing logic of image sensor 122 enables image sensor 122 to receive, capture, and/or convert image light into, for example, image data 120.

Optical system 124 is optically coupled to image sensor 122 and is positioned between image sensor 122 and lens 108. Optical system 124 may include one or more lenses aligned and configured to receive image light from lens 108 and to focus the image light onto image sensor 122. In one embodiment, optical system 124 includes 2, 5, 9, or some other number of lenses or other optical elements that are optically coupled between image sensor 122 and lens 108. Camera system 110 is coupled to processing logic 104 via communications channel 126A. Camera system 110 uses communications channel 126A to communicate with, transfer image data 120 to, and/or receive operational commands from processing logic 104.

Artificial eye system 102 includes iris structure 112 positioned between lens 108 and camera system 110 to define a pupil 129 for image light to pass through, according to an embodiment. Iris structure 112 is formed at least partially within housing 114 and is circular or ring-shaped within housing 114. Iris structure 112 mimics an iris of a human eye. Pupil 129 of iris structure 112 is an opening or aperture within iris structure 112 that allows image light to pass from an inward surface 118 of lens 108 to camera system 110. Pupil 129 defines an entrance opening or an entrance pupil to camera system 110. Iris structure 112 includes a finish that replicates characteristics of a human eye. The finish of the iris structure 112 is a semi-reflective matte finish that may have a color of grey, black, brown, blue, green, red, or some other color that mimics or resembles a human eye. By fabricating iris structure 112 to be semi-reflective and have a color of a human eye, artificial eye system 102 facilitates testing and calibration of eye tracking systems and other head mounted display features, according to an embodiment.

Artificial eye system 102 uses housing 114 to carry, align, and/or orient various components of artificial eye system 102. Housing 114 is fabricated to approximate the size of a human eye, according to one embodiment. Housing 114 is at least partially fabricated in the shape and dimensions of the human eye to enable artificial eye system 102 to mimic functions of a human eye interacting with display 106 and other systems within optical calibration system 100.

Housing 114 includes a cornea region 128 and a sclera region 130. The cornea region 128 houses and/or carries lens 108. Cornea region 128 of housing 114 may be coupled to lens 108 with an adhesive, may be fused to lens 108 (e.g., with heat), or may be fabricated as a single uninterrupted unit that includes lens 108, according to various implementations. Cornea region 128 of housing 114 is fabricated in the shape of a cornea and has a contour that is at least partially human-eye cornea-shaped. Cornea region 128 is aspherical and is fabricated according to the aspherical shape of a human cornea. As the human cornea may individually vary in height and diameter, cornea region 128 may be manufactured according to different specifications to model various types of eyes (e.g., children, elderly, middle-aged adults, diseased, etc.). Sclera region 130 may be fabricated to be spherical and may be fabricated with an average human eye diameter. Sclera region 130 may be fabricated with a diameter of 24 mm or fabricated with a diameter in the range of 22 mm-27 mm. In other implementations, sclera region 130 is fabricated to a diameter that aligns with the size of the cornea region 128. Cornea region 128 and sclera region 130 are manufactured to be translucent and are manufactured from optical quality glass, according to an embodiment. In one embodiment, cornea region 128 is fabricated from optical quality glass, while a portion of sclera region 130 is fabricated from glass. Part of sclera region 130 may be manufactured from plastic, may be opaquely colored, or maybe fabricated to facilitate insertion and removal of camera system 110.

Housing 114 includes a transition region 132 that defines a boundary between cornea region 128 and sclera region 130. Transition region 132 includes curvature that smoothly transitions from the aspherical shape of cornea region 128 to the spherical shape of sclera region 130. Transition region 132 is ring-shaped or oval-shaped around cornea region 128. The smoothness of transition region 132 is fabricated to mimic the transition between a cornea region and a sclera region of a human eye, and transition region 132 facilitates calibration of the eye tracking system of optical calibration system 100.

Optical calibration system 100 may use display 106 to provide display image light 134 to artificial eye system 102, according to an embodiment. Display 106 projects virtual reality (“VR”) images, augmented reality (“AR”) images, mixed-reality (“XR”) images, or other optical information through display image light 134. Display 106 may be driven by optical engine 136, which may be configured to drive holographic waveguide images onto display 106. Display 106 may be opaque and configured to block outside image light 138, according to one embodiment. Display 106 may be implemented as a transparent display receives and passes outside image light 138. Display 106 may combine outside image light 138 with display image light 134 into combined image light 140, which is transmitted to artificial eye system 102 for reception and processing.

Display 106 may be mounted within and carried by a head-mounted display system 142. Head-mounted display (“HMD”) system 142 may include a frame 144 that carries display 106. Head-mounted display system 142 may include a lens 146 that receives outside image light 138 and transmits outside image light 138 into or through display 106, to, at least partially, generate combined image light 140. Head-mounted display system 142 may include support 148, which may be implemented as earpieces of eyeglasses or head straps. Head-mounted display system 142 may also carry and include an eye tracking system 150, which may include cameras, sensors, and/or light sources. Eye tracking system 150 may be positioned onto frame 144, support 148, lens 146, or other portions of head-mounted display system 142. Eye tracking system 150 may be communicatively coupled and/or optically coupled to display 106 through a communication channel 126B.

Optical calibration system 100 is configured to position artificial eye system 102 in a variety of orientations to mimic eye positioning and eye motion of a user interacting with head-mounted display system 142, according to an embodiment. Optical calibration system 100 includes an orientation stage 154 and an orientation controller 156 to rotate and orient artificial eye system 102. Orientation stage 154 is mounted to artificial eye system 102. Orientation stage 154 may carry or suspend artificial eye system 102. Orientation stage 154 may be fabricated using transparent or opaque brackets or a structure that is at least partially shaped like sclera region 130 to mate with at least a portion of housing 114. Orientation stage 154 may be glued, screwed, fused, adhered, or otherwise coupled to housing 114. Orientation stage 154 may include motors, gears, and controllers to rotate artificial eye system 102, up, down, left, and right to enable artificial eye system 102 to receive display image light 134 or combined image light 140 from a number of different orientations.

Orientation controller 156 is physically coupled between orientation stage 154 and processing logic 104, to receive instructions from processing logic 104 and to position orientation stage 154. Orientation controller 156 is communicatively coupled to orientation stage 154 through communication channel 126C, and orientation controller 156 is communicatively coupled to processing logic 104 through communication channel 126D, according to an embodiment. Orientation controller 156 includes logic that enables orientation controller 156 to translate commands from processing logic 104 into electric signals (e.g., pulses, voltage levels, and/or digital signals) used by orientation stage 154 to rotate or orient artificial eye system 102, according to an embodiment.

Processing logic 104 communicates with various components of optical calibration system 100 to facilitate calibration of camera system 110, artificial eye system 102, display 106, and/or head-mounted display system 142. Processing logic 104 may be communicatively coupled to provide instructions to and receive information from image sensor 122, optical engine 136, display 106, eye tracking system 150, and/or orientation controller 156 through communication channels 126A, 126E, 126F, 126G, and 126D, respectively. Communication channels 126A-G may be collectively referenced as communication channels 126. In some implementations, one or more of optical engine 136, orientation controller 156, or portions of eye tracking system 150 may be integrated within processing logic 104.

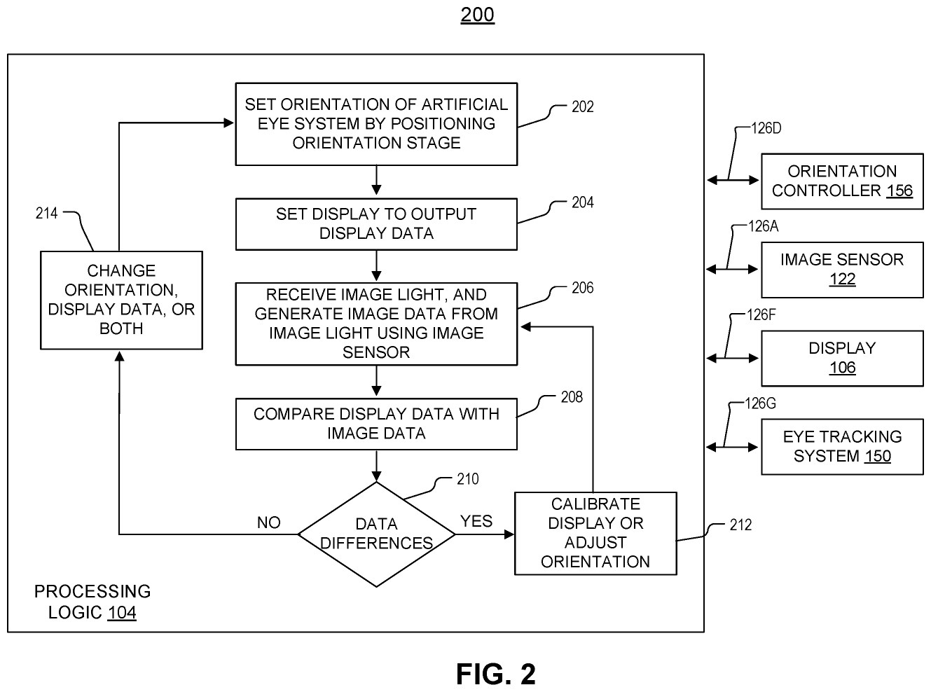

FIG. 2 includes a flow diagram of a process 200 for operating optical calibration system 100, according to an embodiment.

At operation 202, processing logic 104 may be configured to set an orientation of artificial eye system 102 by positioning orientation stage 154. Processing logic 104 may set an orientation of artificial eye system 102 by sending one or more commands to orientation controller 156. The initial orientation set by processing logic 104 may be an orientation that is believed to be a ground zero, home, or origin position from which camera system 110 may receive combined image light 140 from display 106. Operation 202 proceeds to operation 204, according to an embodiment.

At operation 204, processing logic 104 may be configured to set display 106 to output display data as image light. Initially, display data may generate calibration image light of an image that includes a number of shapes at the origin and/or at the corners of display 106. Predetermined shapes, such as diamonds, rectangles, and circles, may be located at specific locations within the image displayed, so that the locations of the shapes being output can be compared to locations of the shapes received by image sensor 122. Comparing predetermined data to captured data can be used to facilitate aligning and calibrating camera system 110 and display 106. Operation 204 proceeds to operation 206, according to an embodiment.

At operation 206, processing logic 104 may be configured to receive image light and generate image data 120 from image light using image sensor 122. Operation 206 proceeds to operation 208, according to an embodiment.

At operation 208, processing logic 104 may be configured to compare display data with image data. Processing logic 104 may compare display data with image data to determine how well aligned camera system 110 is with display 106. Processing logic 104 may be configured to perform a pixel by pixel comparison of display data with image data. Processing logic 104 may be configured to perform a relative comparison of the location of objects (e.g., shapes, images, etc.) of the display data with objects captured in the image data. Operation 208 proceeds to operation 210, according to an embodiment.

At operation 210, processing logic 104 may be configured to determine data differences. If differences are detected between display data and image data, operation 210 may proceed to operation 212. If processing logic 104 does not detect significant differences (e.g., at least 10 pixel difference) between display data and image data, operation 210 may proceed to operation 214, according to an embodiment.

At operation 212, processing logic 104 may be configured to calibrate display 106 or adjust an orientation of artificial eye system 102. Calibrating display 106 or adjusting the orientation of artificial eye system 102 may include re-positioning artificial eye system 102, up, down, left, or right in order to cause objects in the display data to align with objects in the received image data. After an adjustment to display 106 or of artificial eye system 102, operation 212 proceeds back to operation 206, according to an embodiment.

At operation 214, processing logic 104 may be configured to change orientation of artificial eye system 102, change display data displayed by display 106, or change both the orientation and the display data. Processing logic 104 may be configured to adjust the orientation or display data within optical calibration system 100 to capture additional images from, for example, an upper left-hand corner, an upper right-hand corner, a lower left-hand corner, a lower right-hand corner of display 106 or of head-mounted display system 142, according to various embodiments.

In addition to determining alignment between display 106 and image sensor 122, process 200 may include operations for testing and/or calibrating eye tracking system 150. For example, processing logic 104 may set an orientation of artificial eye system 102, may read an eye orientation from eye tracking system 150, and may compare the intended orientation of artificial eye system 102 with the orientation captured or determined by eye tracking system 150.

As discussed in connection with FIG. 1 and FIG. 2, optical calibration system 100 may employ lens 108 (having a cornea shape) and artificial eye system 102 to test and interact with various features of a head-mounted display system 142. Once alignment of artificial eye system 102 (e.g., lens 108 and/or camera system 110) is determined or confirmed, various user interfaces may be displayed and tested on head-mounted display system 142. In a production environment, several pre-determined test images, user interfaces, and/or programs may be run on additional head-mounted displays, and artificial eye system 102 may be used to assure the quality of components such as HMD lenses, displays, and tracking systems.

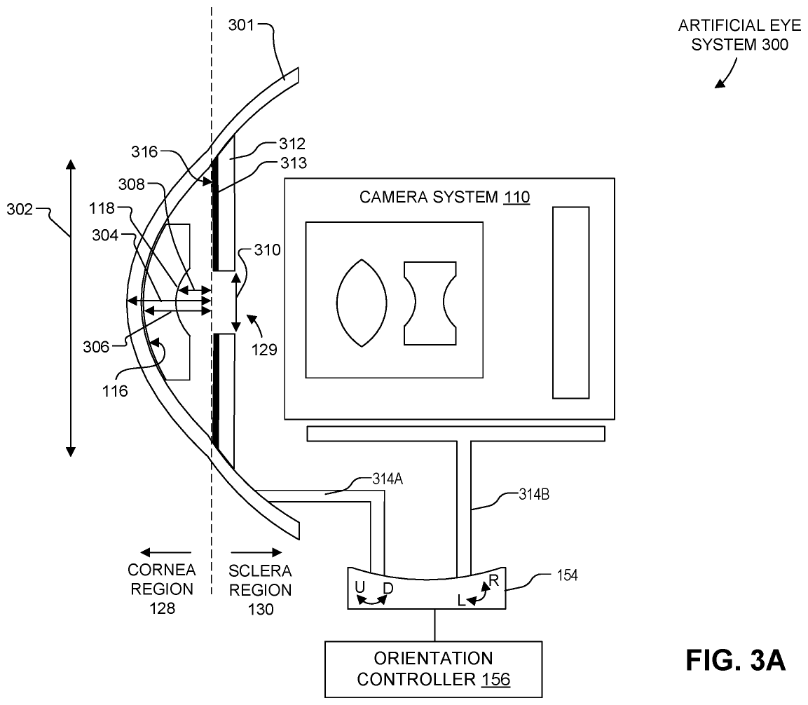

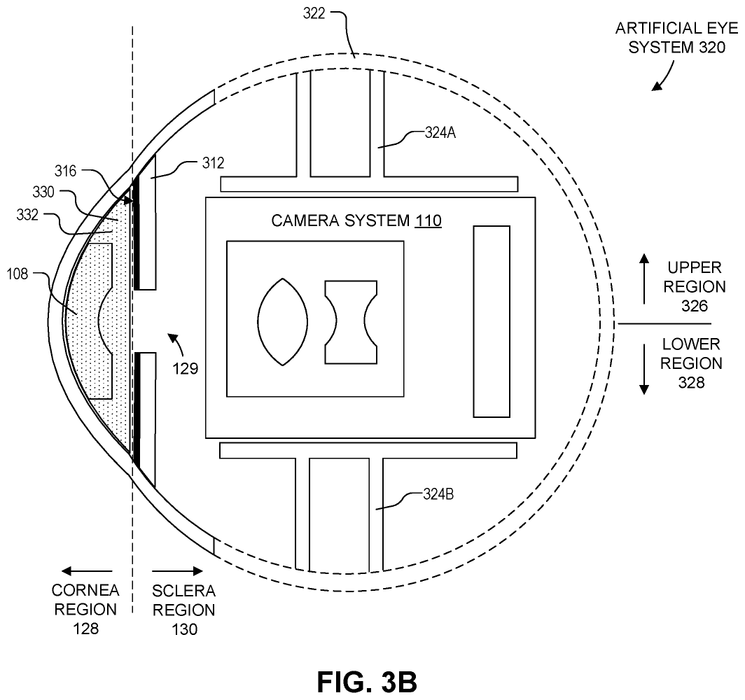

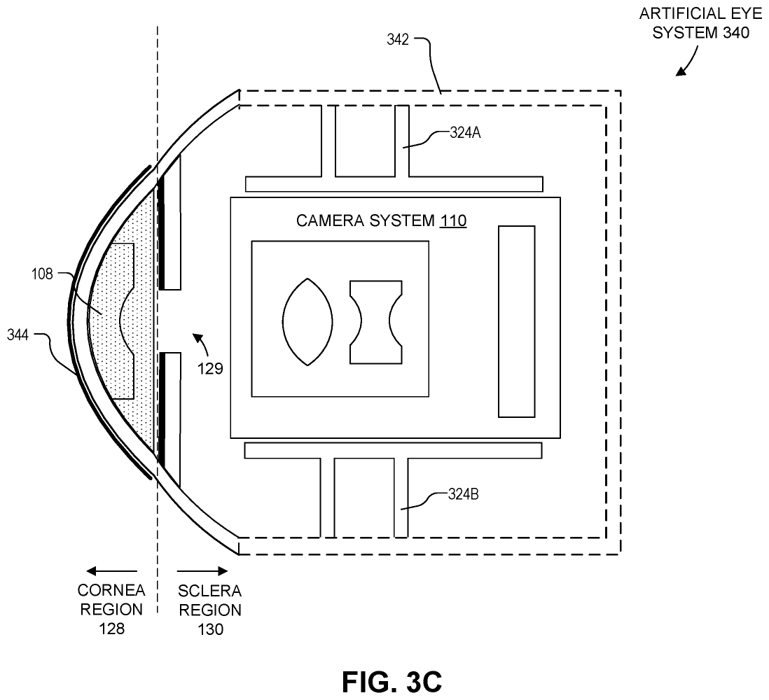

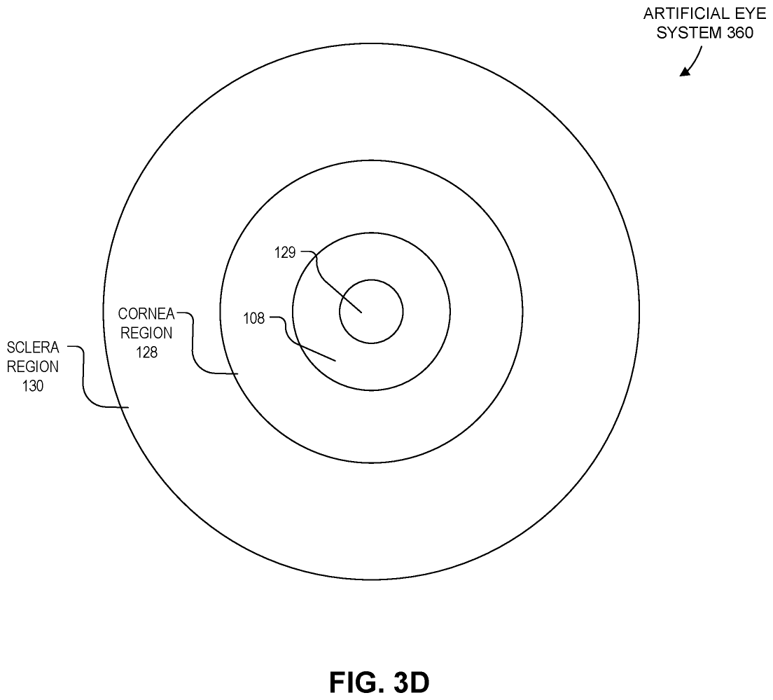

FIGS. 3A, 3B, 3C, and 3D illustrate various embodiments of artificial eye system 102.

FIG. 3A illustrates an artificial eye system 300, according to an embodiment. Artificial eye system 300 is an example implementation of artificial eye system 102 (shown in FIG. 1), according to an embodiment. Artificial eye system 300 illustrates specific examples of features and dimensions related to cornea region 128 and to sclera region 130. Cornea region 128 includes a diameter 302. Diameter 302 may differ for different implementations of artificial eye system 300. For example, implementations of artificial eye system 300 that model a child, adult, or a diseased eye can each have a different diameter of a cornea region 128. Diameter 302 is in a range of 11 mm to 16 mm. Diameter 302 is fabricated to be 15 mm, in an embodiment. Diameter 302 may be a vertical diameter, and cornea region 128 may have a horizontal diameter in a range of 11 mm to 16 mm and that may be different than the vertical diameter.

Artificial eye system 300 includes addition dimensions between pupil 129 and other surfaces. Artificial eye system 300 includes a housing-to-pupil distance 304, a lens entrance-to-pupil distance 306, and a lens exit-to-pupil distance 308. Housing-to-pupil distance 304 is a distance from pupil 129 (from the plane formed by the outward surface of the iris structure) to the center of the outward facing surface of cornea region 128 of housing 301. Housing-to-pupil distance 304 may be in a range of 2 mm to 5 mm. Lens entrance-to-pupil distance 306 is a distance from a center of outward surface 116 of lens 108 to the center of pupil 129. Lens entrance-to-pupil distance 306 may be in a range of 1.5 mm to 4.5 mm. Lens exit-to-pupil distance 308 is a distance from the center of inward surface 118 of lens 108 to the center of pupil 129. Lens exit-to-pupil distance 308 may be in a range of 0 mm to 2 mm. In embodiments where lens 108 is integrated into cornea region 128 of housing 301, housing-to-pupil distance 304 may be the same length as lens entrance-to-pupil distance 306.

Pupil 129 is fabricated with a diameter 310. Various implementations of artificial eye system 300 may be fabricated with different values for diameter 310 of pupil 129. Diameter 310 is fabricated to be 5 mm, in one implementation. However, to model an actual human eye, diameter 310 may be manufactured to be in the range of 2 mm to 8 mm, to simulate capturing image data with a variety of bright and low-light pupil dilation values.

Iris structure 312 is an example implementation of iris structure 112 (shown in FIG. 1). Iris structure 312 is fabricated and attached to housing 301. Iris structure 312 is positioned between lens 108 and camera system 110. Iris structure 312 includes an opening that defines pupil 129. Iris structure 312 includes an iris layer 313 that is fabricated or disposed onto iris structure 312 to mimic optical properties of a human iris. Iris layer 313 may include a matte finish, may be semi-reflective, and may be implemented with one or more eye colors (e.g., grey, brown, black, blue, green, hazel, or some combination thereof). Iris layer 313 is disposed on iris structure 312 on a surface of iris structure 312 that is proximate to and oriented towards lens 108. In other words, iris layer 313 is disposed on an outward facing surface 316 of iris structure 312.

Housing 301 of artificial eye system 300 may include cornea region 128 and a portion of sclera region 130. The partially enclosing housing 301 may partially enclose camera system 110 but may be physically coupled to orientation stage 154 with attachments 314. Attachments 314 may include an attachment 314A and an attachment 314B. Attachment 314A may be implemented as a bracket and that physically couples orientation stage 154 to, for example, sclera region 130 of housing 301. Attachment 314B may be implemented as a bracket that physically carries and couples camera system 110 to orientation stage 154. Attachments 314 may be implemented with opaque and/or translucent materials such as polymer, glass, metal, or the like.

FIG. 3B illustrates an artificial eye system 320, according to an embodiment. Artificial eye system 320 may be one implementation of artificial eye system 102, according to an embodiment. Artificial eye system 320 includes a housing 322 that is fabricated to at least partially enclose camera system 110. Artificial eye system 320 includes attachments 324 that couple camera system 110 to housing 322. Attachments 324 include an upper attachment 324A coupled between an upper region 326 of housing 322 and camera system 110. Attachments 324 may include an attachment 324B that is coupled between camera system 110 and a lower region 328 of housing 322. Cornea region 128 may define a cavity 330 between housing 322 and outward surface 316 of iris structure 312. Cavity 330 includes lens 108 to mimic optical properties of the human eye. Cavity 330 may be at least partially filled with a fluid sac 332. Fluid sac 332 may be filled with water, saline, or another fluid that replicates optical properties of the human eye.

FIG. 3C illustrates an artificial eye system 340 that is an implementation of artificial eye system 102, according to an embodiment. Artificial eye system 340 includes a housing 342 that is at least partially rectangular and that is fabricated from planar materials to support portions of artificial eye system 340. As illustrated, attachments 324 (inclusive of 324A and 324B) are disposed between housing 342 and camera system 110 to carry, support, and couple camera system 110 to housing 342, according to an embodiment.

Artificial eye system 340 includes a hot mirror 344 disposed over cornea region 128 of housing 342, according to an embodiment. Hot mirror 344 reflects infrared light and passes visible light. Hot mirror 344 is a coating that is applied over at least part of cornea region 128 of housing 342. Reflecting infrared light may enable eye tracking systems to externally determine an orientation of artificial eye system 340, which may enable alignment and performance verification of eye tracking systems, camera system 110, and the orientation controller.

FIG. 3D illustrates a front view of artificial eye system 360, which may be an implementation of artificial eye system 102, according to an embodiment.

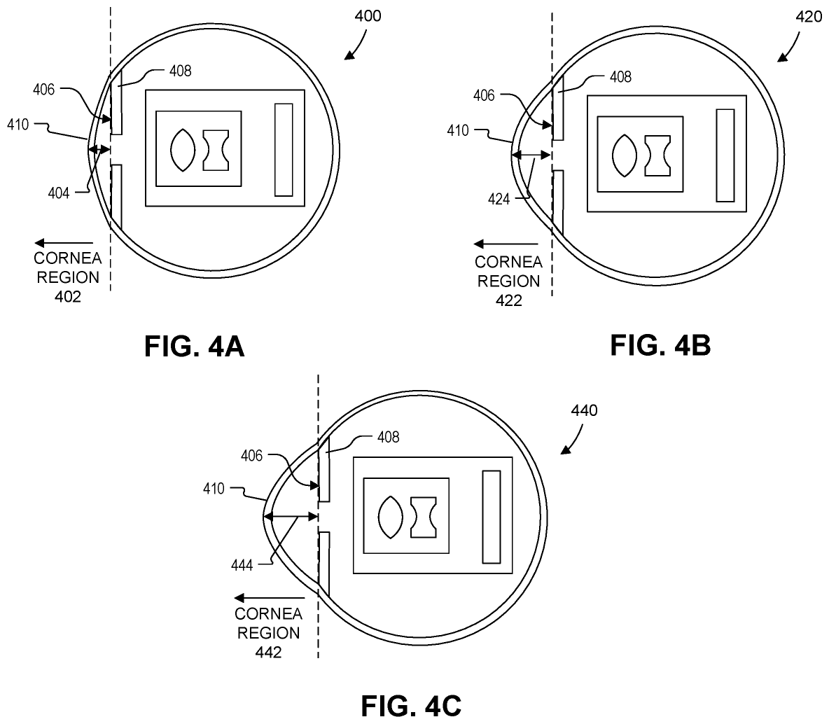

FIGS. 4A, 4B, and 4C illustrate embodiments of different shapes of cornea regions for an artificial eye system. FIG. 4A illustrates an artificial eye system 400 having a cornea region 402 that has a height 404 that is relatively low. Height 404 is a distance from the plane of an outward surface 406 of an iris structure 408 to outward surface 410 of cornea region 402. Height 404 may be defined from a center of pupil 129 to a center of cornea region 402. In this low-profile embodiment, height 404 may be fabricated to be 2 mm. Height 404 may be fabricated to be in a range of 1.5 mm to 2.5 mm.

FIG. 4B illustrates an artificial eye system 420 having a cornea region 422 with a height 424. In this mid-profile embodiment, height 424 may be fabricated to be 3 mm. Height 424 may be fabricated to be in a range of 2.5 mm to 3.5 mm.

FIG. 4C illustrates an artificial eye system 440 having a cornea region 442 with a height 444. In this high-profile embodiment, height 444 may be fabricated to be 4 mm. Height 444 may be fabricated to be in a range of 3.5 mm to 4.5 mm, or greater.

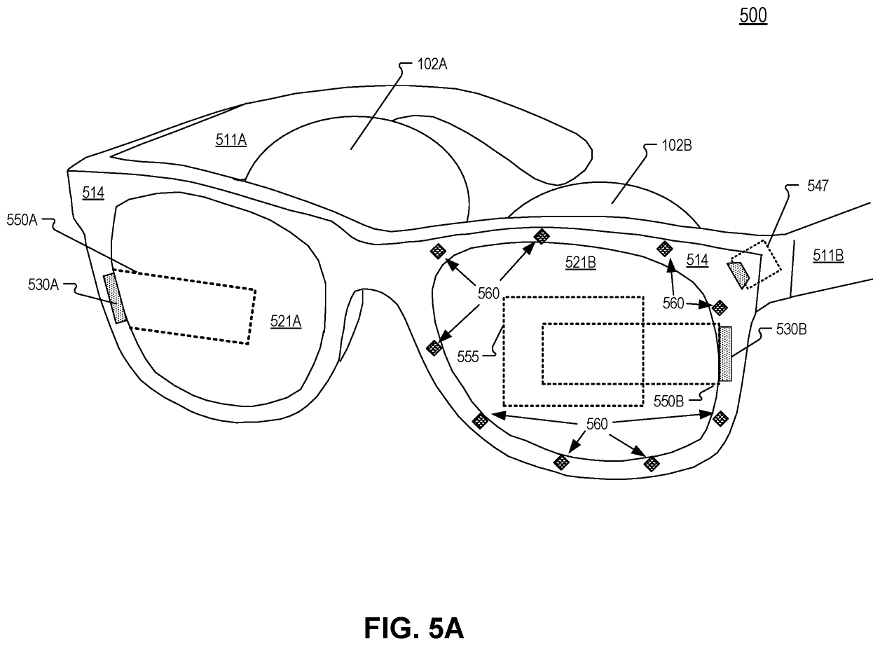

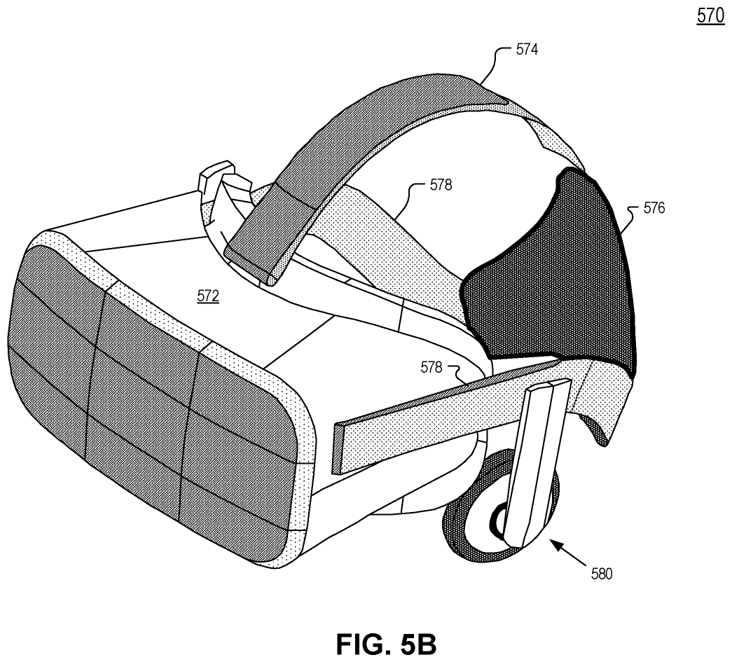

FIGS. 5A and 5B illustrate example implementations of head-mounted display (“HMD”) system 142 (shown in FIG. 1).

FIG. 5A illustrates an example HMD 500 that may be used in optical calibration system 100 (shown in FIG. 1), in accordance with an embodiment of the disclosure. HMD 500 includes frame 514 coupled to arms 511A and 511B. Lenses 521A and 521B are mounted to frame 514. Lenses 521 may be prescription lenses matched to a particular wearer of HMD or non-prescription lenses. The illustrated HMD 500 is configured to be worn on or about a head of a user of the HMD.

In FIG. 5, each lens 521 includes a waveguide 550 (individually, 550A and 550B) to direct image light generated by a display 530 to an eyebox area for viewing by a wearer of HMD 500. Display 530 may include an LCD, an organic light emitting diode (OLED) display, micro-LED display, quantum dot display, pico-projector, or liquid crystal on silicon (LCOS) display for directing image light to a wearer of HMD 500.

The frame 514 and arms 511 of the HMD 500 may include supporting hardware of HMD 500. HMD 500 may include any of processing logic, wired and/or wireless data interface for sending and receiving data, graphic processors, and one or more memories for storing data and computer-executable instructions. In one embodiment, HMD 500 may be configured to receive wired power. In one embodiment, HMD 500 is configured to be powered by one or more batteries. In one embodiment, HMD 500 may be configured to receive wired data including video data via a wired communication channel. In one embodiment, HMD 500 is configured to receive wireless data including video data via a wireless communication channel.

Lenses 521 may appear transparent to a user (or to artificial eye system 102) to facilitate augmented reality or mixed reality where a user (or to artificial eye system 102) can view scene light (or outside image light) from the environment around her while also receiving display image light directed to her eye(s) by waveguide(s) 550. Consequently, lenses 521 may be considered (or include) an optical combiner. In some embodiments, image light is only directed into one eye of the wearer of HMD 500. In an embodiment, both displays 530A and 530B are included to direct image light into waveguides 550A and 550B, respectively.

The example HMD 500 of FIG. 5 includes an array of infrared emitters (e.g., infrared LEDs) 560 disposed around a periphery of lens 521B in frame 514. The infrared emitters emit light in an eyeward direction to illuminate an artificial eye system 102A and 102B (collectively, artificial eye system 102) with infrared light. In one embodiment, the infrared light is centered around 850 nm. Infrared light from other sources may illuminate the eye as well. The infrared light may reflect off the eye and be received by a Fresnel reflector selectively coated with a hot mirror and configured to direct and focus the reflected infrared light to camera 547. Camera 547 may be mounted on the inside of the temple of HMD 500. The images of the artificial eye system 102 captured by camera 547 may be used for eye-tracking purposes.

FIG. 5B illustrates an example head-mounted display 570 that may be used in optical calibration system 100 (shown in FIG. 1), in accordance with an embodiment of the disclosure. HMD 570 includes a viewing structure 572. Hardware of viewing structure 572 may include any of processing logic, wired and/or wireless data interface for sending and receiving data, graphic processors, and one or more memories for storing data and computer-executable instructions. In one embodiment, viewing structure 572 may be configured to receive wired power. In one embodiment, viewing structure 572 is configured to be powered by one or more batteries. In one embodiment, viewing structure 572 may be configured to receive wired data including video data. In one embodiment, viewing structure 572 is configured to receive wireless data including video data.

HMD 570 includes a top structure 574, a rear securing structure 576, and a side structure 578 attached to viewing structure 572. HMD 570 is configured to be worn on a head of a user of the HMD. In one embodiment, top structure 574 includes a fabric strap that may include elastic. Side structure 578 and rear securing structure 576 may include a fabric as well as rigid structures (e.g., plastics) for securing the HMD to the head of the user. HMD 570 may optionally include earpiece(s) 580 configured to deliver audio to the ear(s) of a wearer of HMD 570.

Viewing structure 572 may include an OLED display for directing image light to artificial eye system 102 (shown in FIG. 1). Viewing structure 572 may also include a GPU and processing logic that includes one or more processors, microprocessors, multi-core processors, Application-specific integrated circuits (ASIC), and/or Field Programmable Gate Arrays (FPGAs) to execute display, VR, AR, or XR operations. In some embodiments, memory may be integrated into the processing logic to store instructions to execute operations and/or store data. Processing logic may also include analog or digital circuitry to perform the operations in accordance with embodiments of the disclosure.

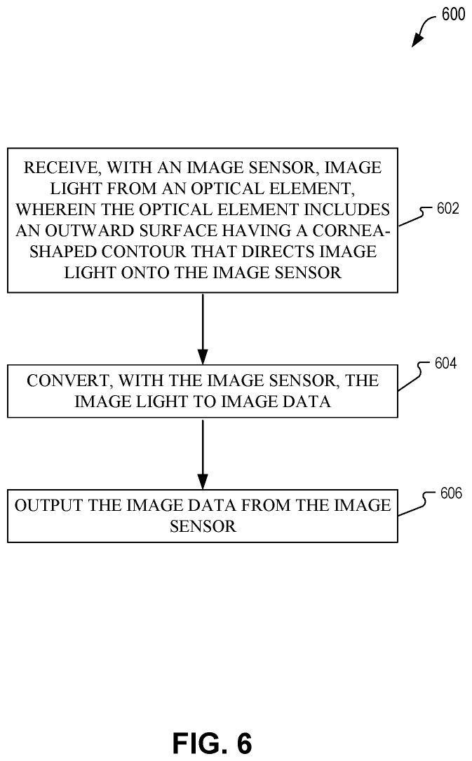

FIG. 6 illustrates a process for operating an artificial eye system, according to an embodiment of the disclosure. The order in which some or all of the process blocks appear in process 600 should not be deemed limiting. Rather, one of ordinary skill in the art having the benefit of the present disclosure will understand that some of the process blocks may be executed in a variety of orders not illustrated, or even in parallel.

In block 602, process 600 receives, with an image sensor, image light from an optical element, wherein the optical element includes an outward surface having a cornea-shaped contour that directs image light onto the image sensor, according to an embodiment. Block 602 proceeds to block 604, according to an embodiment.

In block 604, process 600 converts, with the image sensor, the image light to image data, according to an embodiment. Block 604 proceeds to block 606, according to an embodiment.

In block 606, process 600 outputs the image data from the image sensor, according to an embodiment.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g., processing logic 104) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” (e.g., 160) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Communication channels 126 may include or be routed through one or more wired or wireless communication utilizing IEEE 802.11 protocols, Bluetooth, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A device comprising:
a housing that includes a cornea-shaped region and a sclera-shaped region, wherein the housing is fabricated from glass or plastic;
an iris structure attached to the housing and positioned within the housing;
an image sensor configured to receive image light that passes through the cornea-shaped region of the housing; and
a lens assembly configured to focus the image light into an opening of the iris structure and onto the image sensor, wherein an optical element of the lens assembly is positioned between the iris structure and the cornea-shaped region of the housing, wherein the optical element includes an outward surface, wherein the outward surface includes a cornea-shape having a contour like a cornea of a human eye.

2. The device of claim 1, wherein the housing includes a shoulder transition curve between the cornea-shaped region and the sclera-shaped region of the housing.

3. The device of claim 1, wherein a hot mirror layer is disposed over the cornea-shape of the outward surface of the optical element, wherein the hot mirror layer is configured to reflect infrared light and pass visible light.

4. The device of claim 1, wherein the iris structure defines an entrance pupil of the lens assembly, wherein the iris structure is positioned between the optical element and the image sensor, wherein the iris structure is ring-shaped.

5. The device of claim 1, wherein the iris structure includes a cornea-facing surface and a sclera-facing surface, wherein the cornea-facing surface of the iris structure includes a semi-reflective matte finish that is configured to simulate characteristics of a human eye iris.

6. The device of claim 5, wherein the matte-finish of the iris structure is grey, black, brown, blue, or green.

7. The device of claim 1, wherein the lens assembly further includes an optical system positioned between the image sensor and the iris structure.

8. The device of claim 7, wherein the optical element is a first optical element, wherein the optical system includes a plurality of second optical elements that focus the image light from the first optical element to the image sensor, and wherein only the first optical element includes an aspherical outward surface.

9. A system comprising:
processing logic that includes instructions for selectively operating components of an optical calibration system;
a display coupled to the processing logic to receive display data from the processing logic, wherein the display outputs the display data as image light; and
an artificial eye system coupled to the processing logic to transfer image data to the processing logic, wherein the artificial eye system is configured to receive the image light and is configured to convert the image light to image data, wherein the artificial eye system includes:
a housing having a cornea-shaped region and a sclera-shaped region,
wherein the housing is fabricated from glass or plastic;
an iris structure attached to the housing and positioned within the housing;
an optical element carried by the housing and positioned between the iris structure and the cornea-shaped region of the housing, wherein an outward surface of the optical element includes a cornea-shaped contour; and
an image sensor positioned and configured to receive the image light that passed through the sclera-shaped portion of the housing and through the optical element.

10. The system of claim 9, wherein the housing includes a transition curve between the cornea-shaped region and the sclera-shaped region of the housing.

11. The system of claim 9, wherein a hot mirror layer is disposed over the outward surface of the optical element, wherein the hot mirror layer is configured to reflect infrared light and pass visible light.

12. The system of claim 9, wherein the cornea-shaped contour of the outward surface is aspherical, wherein the iris structure is positioned between the optical element and the image sensor, the iris structure being coupled to the housing and having an aperture that defines an entrance pupil.

13. The system of claim 9 further comprising:
a head mounted display system, wherein the head mounted display system includes:
a lens coupled to the display;
a frame configured to carry the lens and the display; and
an eye tracking system that includes light sources and light detectors mounted on the frame and configured to identify an orientation of an eye.

14. The system of claim 13, wherein the eye tracking system is coupled to the processing logic to receive operational commands and to provide eye tracking data.

15. The system of claim 9 further comprising:
an orientation stage coupled to the housing to define an orientation of the artificial eye system; and
an orientation controller coupled between the orientation stage and the processing logic.

16. A calibration system comprising:
at least one processing logic;
one or more memories coupled to the at least one processing logic, the one or more memories storing instructions that when executed by the at least one processing logic, cause the calibration system to perform operations comprising:
provide display data to a display to enable the display to output the display data as image light
orient a lens assembly to receive the image light with an optical element, wherein the lens assembly includes a housing, wherein the optical element is at least partially carried by the housing;
receive, with an image sensor, the image light from the optical element, wherein the optical element includes an outward surface having a cornea-shaped contour that directs image light onto the image sensor;
convert, with the image sensor, the image light to image data;
receive the image data from the image sensor; and
compare the display data to the image data to characterize operation of the display.

17. (canceled)

18. The calibration system of claim 6, wherein the instructions, when executed by the at least one processing logic, cause the calibration system to perform operations further comprising:
compare an orientation from an eye tracking system to an orientation of an orientation stage and orientation controller.

19. The calibration system of claim 16, wherein the instructions, when executed by the at least one processing logic, cause the calibration system to perform operations further comprising:
adjust an orientation of the image sensor at least partially based on differences identified between the display data and the image data.

20. The calibration system of claim 16, wherein receive the image light with the image sensor includes receive the image light through an entrance pupil defined as an aperture by an iris structure that is positioned between the image sensor and the optical element.

21. The device of claim 1, wherein the sclera-shaped region of the housing includes a first diameter and the cornea-shaped region of the housing includes at least one second diameter, wherein the first diameter is larger than the at least one second diameter.
